(19) United States
(12) Patent Application Publication
(10) Pub. No.: US 2020/0019964 A1
(43) Pub. Date: Jan. 16, 2020

(54) SYSTEMS AND METHODS FOR USE IN PERMITTING RESTRICTED NETWORK TRANSACTIONS

(71) Applicant: MASTERCARD INTERNATIONAL INCORPORATED, Purchase, NY (US)

(72) Inventors: Matthew James Miller, Kaneohe, HI (US); Mikel J. Irkliewskij, Lagrange, NY (US); Adam Kenneth Hosp, Lake St. Louis, MO (US)

(21) Appl. No.: 16/508,880

(22) Filed: Jul. 11, 2019

Related U.S. Application Data
(60) Provisional application No. 62/696,631, filed on Jul. 11, 2018.

(51) Int. Cl. G06Q 20/40; G06Q 20/38; G06Q 20/32

(52) U.S. Cl. CPC G06Q 20/405; G06Q 20/38215; G06Q 20/3274; G06Q 20/388

(57) ABSTRACT

Systems and methods are provided for use in permitting restricted network transactions. One exemplary method includes receiving a product identifier associated with a product, from a user at a communication device, where the product is offered for sale by a merchant associated with a restricted merchant category for a payment account associated with the user. The method also includes identifying the product based on the identifier, from a listing of products included in a data structure, and determining whether the product is permitted based on one or more permission rules associated with an account host for the payment account. The method then includes transmitting an approve notification to the user, at the communication device, when the product is permitted by the one or more permission rules.

### CROSS-REFERENCE TO RELATED APPLICATION

This application claims the benefit of, and priority to, U.S. Provisional Application No. 62/696,631 filed on Jul. 11, 2018. The entire disclosure of the above-referenced application is incorporated herein by reference.

### FIELD

The present disclosure generally relates to systems and methods for use in permitting restricted network transactions.

### BACKGROUND

This section provides background information related to the present disclosure which is not necessarily prior art.

People are known to use payment accounts to fund transactions for the purchase of products (e.g., goods and services, etc.). As they pertain to business, for example, employees (or others) are known to receive corporate payment accounts, which are sponsored and/or paid for by companies (e.g., in the form of corporate cards, fleet cards, etc.), to enable the employees to make purchases relating to their work, etc., without having to pay themselves and then seek reimbursement. In general, the payment accounts are provided to the employees and are often associated with limitations and/or restrictions on how and for what products the payment accounts may be used. Such limitations and/or restrictions may be instructions to the persons regarding such use, or they may be implemented in authorization processing for the payment accounts.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in permitting restricted network transactions;

FIG. 2 is a block diagram of a computing device that may be used in the exemplary system of FIG. 1;

FIG. 3 is an exemplary method that may be implemented in the system of FIG. 1 for use in permitting restricted network transactions, by a user, based on a virtual account number (VCN);

FIG. 4 is an exemplary method that may be implemented in the system of FIG. 1 for use in permitting restricted network transactions, by a user, based on QR codes provided from merchants; and

FIG. 5 is an exemplary method that may be implemented in the system of FIG. 1 for use in permitting restricted network transactions, by a user, based on permission instructions provided to the user.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When payment accounts are provided to users, by companies, businesses, or other authorities, use of the payment accounts in performing different network transactions may be restricted by account hosts (associated with the payment accounts) in a number of manners. For example, payment accounts may be restricted based on merchants having a particular merchant category code (MCC) (e.g., a whitelist or blacklist of MCCs, etc.), or the payment accounts may be restricted based on certain thresholds (e.g., no transactions over $250.00, etc.). As to such payment accounts, then, certain transactions may be identified as restricted transactions and not allowed. While such restrictions are imposed to protect the companies, businesses, or authorities from being forced to fund purchases for unauthorized and/or improper products or services, the restrictions may also (inadvertently) restrict legitimate purchases.

Uniquely, the systems and methods herein permit certain restricted network transactions to still proceed to the payment accounts, despite contrary restrictions being associated with the payment accounts by the account hosts. In particular, a permission engine computing device cooperates with a permission application at a user's communication device to identify products to be purchased by the user (e.g., an employee, etc.) via his/her “restricted” payment account, which would normally be not allowed. The permission engine computing device applies rules, setup by the account host (e.g., an employer, etc.), to then permit the user to still purchase the products, consistent with the underlying intent of the payment account being provided by the account host to the user, even though such purchase would normally be restricted. In this manner, account hosts have the ability to impose broad restrictions on payment accounts provided to users, but also the ability to further provide certain permissions, at the product level, for the payment accounts which overcome or override the broad restrictions. As can be appreciated, this additional ability of the account hosts may reduce friction in use of the payment accounts by the users to purchase products tied to their relationship with the account hosts and authorized by the account hosts (even though potentially denied by the broader restrictions implemented by the account hosts on the payment accounts).

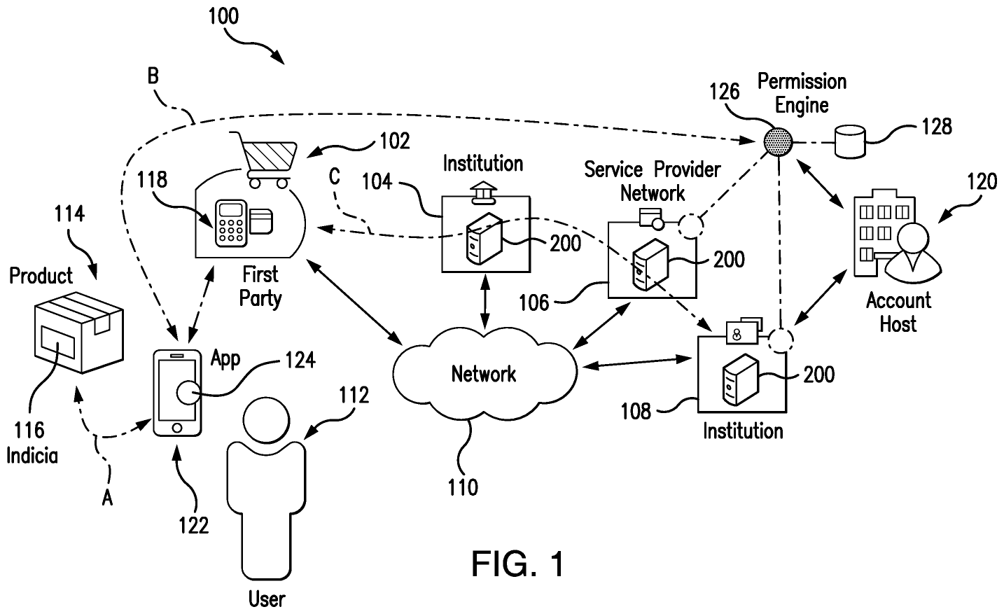

FIG. 1 illustrates an exemplary system 100, in which one or more aspects of the present disclosure may be implemented. Although the system 100 is presented in one arrangement, other embodiments may include systems arranged otherwise depending, for example, on the manner in which transactions are authorized, on the manner in which restrictions are imposed, on the restrictions to be imposed, on privacy policies associated with the accounts, etc.

The system 100 generally includes a first party 102 (e.g., a merchant, etc.), an acquirer institution 104 associated with the first party 102 (and configured to process purchase transactions performed at the first party 102), a service provider network 106 (e.g., a payment network, etc.), and an issuer institution 108 configured to issue payment accounts to users, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 110 may include multiple different networks, such as a private payment transaction network made accessible by the service provider network 106 to the acquirer institution 104 and the issuer institution 108 and, separately, the public Internet, which may be accessible as desired to the first party 102, the acquirer institution 104, and the issuer institution 108, etc.

In this embodiment, the first party 102 includes a merchant (also referred to herein as merchant 102) configured to offer and sell products (e.g., goods, services, etc.) to consumers including, for example, user 112. The products may include any suitable and/or desired products within the scope of the present disclosure. In connection therewith, the merchant 102 is generally associated with one or more physical locations and/or virtual locations (e.g., websites, etc.), through which the products are offered for sale and/or are sold to the consumers. As shown in FIG. 1, the system 100 includes a product 114, which is offered for sale at a physical location of the merchant 102. The product 114 is marked with a computer-readable indicia 116, which may include, for example, a barcode, etc. That said, the indicia 116 may alternatively be a quick response (QR) code in other embodiments, or otherwise, and may be human readable (as well) or not, etc. In general, the indicia 116 includes and/or provides an identifier of the product 114 (e.g., a Universal Product Code (UPC), etc.) and/or details of the product 114 (e.g., a name, a description, a model identifier, a manufacturer, a product identifier, etc.), which may be specific to the merchant 102, or generic to multiple merchants, etc.

Also in this embodiment, the merchant 102 includes a point-of-sale (POS) terminal (or device) 118. The POS terminal 118 is a computing device configured to interact with the product 114 and the indicia 116 associated therewith and/or a payment device (e.g., a payment card, a virtual wallet, etc.) and/or a user (such as the user 112), for example, to acquire product details and/or payment account credential(s) in connection with a purchase of the product 114 (and other products), and to otherwise coordinate authorization of transactions performed at the merchant 102, as described in more detail below.

It should be appreciated that, in the illustrated embodiment, the acquirer institution 104 and the issuer institution 108 are both banking institutions. However, this is not required in all embodiments. For example, in other embodiments one or both of the acquirer institution 104 and the issuer institution 108 may be other, different financial institutions or other non-financial institutions.

The system 100 also includes an account host 120 associated with the user 112 (and in communication with the network 110, even though not expressly illustrated as such by an arrow in FIG. 1). In general, the account host 120 acquires a payment account issued by the issuer institution 108 and provides the payment account to the user 112. In several embodiments, the account host 120 is a business, and the user 112 is an employee, contractor or worker for the business. The payment account is then provided by the account host 120 to the user 112 to fund transactions for products related to the employment of the user 112. Specifically, in the embodiment of FIG. 1, the account host 120 may include a fleet operator, and the payment account may be a fleet account intended for the purchase of gasoline, vehicle maintenance items, etc., for the user's work as a driver for the fleet operator. In another example, however, the account host 120 may be a business of another type, and the user may be an employee of the business with an expense account. In still other examples, the account host 120 may include one or more parents, and the user 112 may be a nanny, housekeeper, or other employee, or even a child or dependent of the parents. It should be appreciated that the account host 120 and the user 112 may be defined through still other relationships, where the account host 120 provides and/or is associated with the payment account, and is able to impose restrictions of the payment account for its use by the user 112 as generally described herein (through application of the present disclosure).

The payment account of the user 112, then, is subject to multiple restrictions, which may be based on merchant categories (e.g., MCCs, etc.), particular merchants, product descriptions, locations (e.g., postal codes, etc.), transaction amounts, past occurrences of fraud, days of the week, times of day, etc. The restrictions, regardless of type, are defined by the account host 120 for the particular payment account provided to the user 112 (and/or accessible by the user 112 and other users associated with the account host 120) and/or for the users to whom the account host 120 provides payment accounts (including the user 112).

In general, the restrictions are defined during a setup of the payment account, by the account host 120, and stored in the issuer institution 108 that issued the payment account (e.g., in a computing device associated with the issuer institution 108, etc.). In turn, the issuer institution 108 is configured to impose the restrictions on transactions directed to the payment account, in connection with authorization of the transactions, as described below. In another embodiment, the restrictions may be provided to and/or stored at the service provider network 106, whereby the service provider network 106 then is configured to impose the restrictions on transactions directed to the payment account and passing through the service provider network 106, as described below.

As an example, the payment account provided to the user 112 (by the account host 120) may be restricted from purchases at a variety of merchant categories, such as, for example, MCC 5200 for home supply warehouses and MCC 5411 for grocery stores (e.g., as part of a blacklist of MCCs, etc.), but permitted for purchases in: MCC 5531 for auto supply stores, MCC 5532 for automotive tire stores, and MCC 5533 for automotive parts and accessories stores (e.g., as part of a whitelist of MCCs, etc.). Of note, in this example, the merchant 102 is a home supply store and is associated with MCC 5200 (and thus is associated with a restricted merchant category for the user's payment account). It should be appreciated that the particular MCCs listed above are for purposes of illustration only in this example, and that other MCCs may be whitelisted and/or blacklisted in other embodiments depending on, for example, types of users, types of account hosts, relationships between users and account hosts, prior occurrences of fraud, etc Likewise, the imposed restrictions may be any suitable restrictions related to merchants, products, locations, transaction amounts, days of the week, times of day, etc.

With continued reference to FIG. 1, the user 112 is associated with a communication device 122. The communication device 122 may include, for example, a smartphone, a laptop, a tablet, etc. Often, though, the communication device 122 will include a portable communication device, so that the communication device 122 may be carried with the user 112, for use as described herein. The communication device 122 includes a permission application 124, which configures the communication device 122 to operate as described herein (and perform one or more of the operations described herein). In particular, the permission application 124 may include executable instructions in the form of an application (or app) specific to seeking permission for restricted purchases to the user's payment account. Conversely, the permission application 124 may include executable instructions that configure the communication device 122 to perform additional operations, such as, for example, payment operations, etc., whereby the permission application 124 may also be considered (or included in) a virtual wallet application or electronic wallet application. In such embodiments, the permission application 124 may be provided (e.g., as a software development kit (SDK), etc.) by the service provider network 106 and/or the issuer institution 108, or even the merchant 102, and, potentially, branded consistent with the provider thereof (e.g., an ACME Bank virtual wallet, or an ACME Merchant virtual wallet, or etc.). The permission application 124 may further be appended or included as part of a different virtual wallet, such as, for example, the MasterPass® virtual wallet from Mastercard®, the Apple Pay® virtual wallet from Apple®, the Samsung Pay® virtual wallet from Samsung®, etc.

The system 100 further includes a permission engine 126, which is configured, by executable instructions, to operate as described herein (and perform one or more of the operations described herein). The permission engine 126 may include a standalone computing device, as shown, or may be incorporated and/or integrated, in whole or in part, with the service provider network 106 and/or the issuer institution 108, as indicated by the dotted lines and dotted circles (or otherwise in the system 100). A data structure 128 is coupled in communication with the permission engine 126. Like the permission engine 126, the data structure 128 may be a standalone computing device, or may be incorporated and/or integrated, in whole or in part, with the permission engine 126, the service provider network 106, and/or the issuer institution 108.

In this exemplary embodiment, the data structure 128 includes different data structures to be used by the permission engine 126. In particular, the data structure 128 includes a listing of products by product identifier (e.g., by UPC, etc.). The listing may be specific to the merchant 102 or generic to multiple different merchants, manufacturers, etc. When the listing of products is specific to the merchant 102, for example, the data structure 128 may further include a geolocation definition of the merchant 102. In addition, the listing of products in the data structure 128 may further include estimated costs (or ranges of estimated costs) for the products, or source(s) from which the estimated cost(s) for the product(s) may be obtained and/or estimated (e.g., via a network-based application, website, etc.). In one example, an online price comparison tool (e.g., PriceGrabber, Shopzilla, BizRate, Google Shopping, NexTag, etc.) may be used to determine a series of estimated costs from which a single estimated cost (e.g., an average, etc.) or range of estimated costs may be determined for the given product(s). The estimated cost or range of estimated costs may then be included in the data structure with the given product(s).

The data structure 128 may also include user profiles and account host profiles. The user profiles may include, without limitation, contact information for the users to which they relate, etc. The account host profiles may include, without limitation, contact information, listings of restrictions (e.g., restriction rules specific to payment accounts issued by the account host 120, etc., as described above), and permission rules setup by the account hosts to which they relate, etc. In connection therewith, the permission rules may be specific to users and/or products, or general to the corresponding accounts and/or account hosts. In general, the permission rules define exceptions to the restrictions on the payment accounts, whereby restricted transactions will be permitted. In the above example, the account host 120 has setup or generated, and the account host profile for the account host 120 includes, multiple different permission rules, which provide product permissions for windshield wipers, oil changes, mud flaps, and other permitted fleet-related products, etc., regardless of merchant (or MCC associated with the merchant). As described herein, the permissions may be directed to specific products (e.g., ABC brand windshield wipers having size XX, etc.) or they may be directed to categories of products (e.g., windshield wipers, automotive products, etc.).

With that said, it should be appreciated that permission rules may be specific to a location, a merchant, etc. for a product (or category of products), or the permission rules may be general. It should also be appreciated that, beyond the above fleet example, permission rules may vary depending on, for example, types of users, types of account hosts, relationships between the users and the account hosts, types of products and merchants, past occurrences of fraud, etc.

After the permission rules are setup, when the user 112 is shopping at the merchant 102, the merchant 102 may be identified to the permission engine 126 and/or the communication device 122 (since the user 112 is generally restricted from using his/her payment account at the merchant 102 based on the merchant's MCC). Specifically, when a listing of products in the data structure 128 includes a geolocation for the merchant 102, the communication device 122 may be configured to detect the presence of the user 112 at the merchant 102 (via communication between the application 124 and the permission engine 126) based on a location of the user 112 (e.g., determined based on GPS and communicated to the application 124, etc.) being the same as (or within an acceptable variance of) the geolocation of the merchant 102. In other embodiments, the presence of the user 112 at the merchant may be determined based on an input from the user 112 (e.g., a selection of the merchant from a pull-down menu, entry of merchant name, etc.), at the start of shopping or at checkout, or sometime therebetween (e.g., by selecting the merchant 102 from a list and/or by entering the name and/or location of the merchant 102, etc.).

Then, when the user 112 desires to purchase product 114 from the merchant 102, for example, windshield wipers, because the user 112 is generally restricted from using his/her payment account at the merchant 102, the user 112 access the permission application 124 at the communication device 122. In turn, the communication device 122, as configured by the permission application 124, invites the user 112 to identify the merchant 102 (if not already done via the current location of the user 112 matching the defined geolocation of the merchant 102) and to scan or otherwise identify the product 114 to be purchased from the merchant 102. The user 112, in this embodiment, directs a camera input device of the communication device 122 to the indicia 116 of the product 114, and selects an input. In turn, the communication device 122, as configured by the permission application 124 (and/or the operating system of the communication device 122), captures an image of the indicia 116 of the product 114, as indicated path A in FIG. 1. The communication device 122, as configured by the permission application 124, determines a product identifier, such as, for example, a UPC, from the indicia 116, and transmits the product identifier to the permission engine 126, along path B.

In response, the permission engine 126 is configured to query the listing of products in the data structure 128 (e.g., associated with the identified merchant 102, etc.), thereby identifying the product 114. When the product 114 is identified, the permission engine 126 is configured to determine whether the product 114 is permitted based on the permission rules setup by the account host 120 and to transmit an approve or deny notification back to the user 112 at the permission application 124 of the communication device 122. In addition, when approved, the permission engine 126 is configured to determine a price or price approximation for the product (e.g., through the listing of products and/or through a price listing in the data structure 128, or other source; etc.) and to include the same in the approval or denial back to the user 112. The permission engine 126 then generates a purchase file for the user 112 and/or the merchant 102, which includes the product identifier and the cost of the product, and stores the purchase file while the user 112 continues to shop at the merchant 102.

As the user 112 desires to purchase additional products at the merchant 102, through use of his/her payment account provided by the account host 120, the above operations are repeated for each product. In connection therewith, the permission engine 126 may be configured to append the additional product identifiers and associated costs (or cost ranges) to the purchase file.

It should be appreciated that when a permission rule does not exist for an identified product, the permission engine 126 may be configured to seek permission from the account host 120 (e.g., a user, manager, director, or officer at the account host 120, etc.), based on contact information included in the account host profile. When the account host 120 responds with permission, the permission engine 126 is configured to proceed with the permission as if provided through one or more rules. However, when the account host 120 responds with a decline (or, potentially, when the account host does not respond at all), the permission engine 126 may be configured to transmit a deny notification to the user 112 (at the communication device 122) in which case the selected product is not appended to the purchase file.

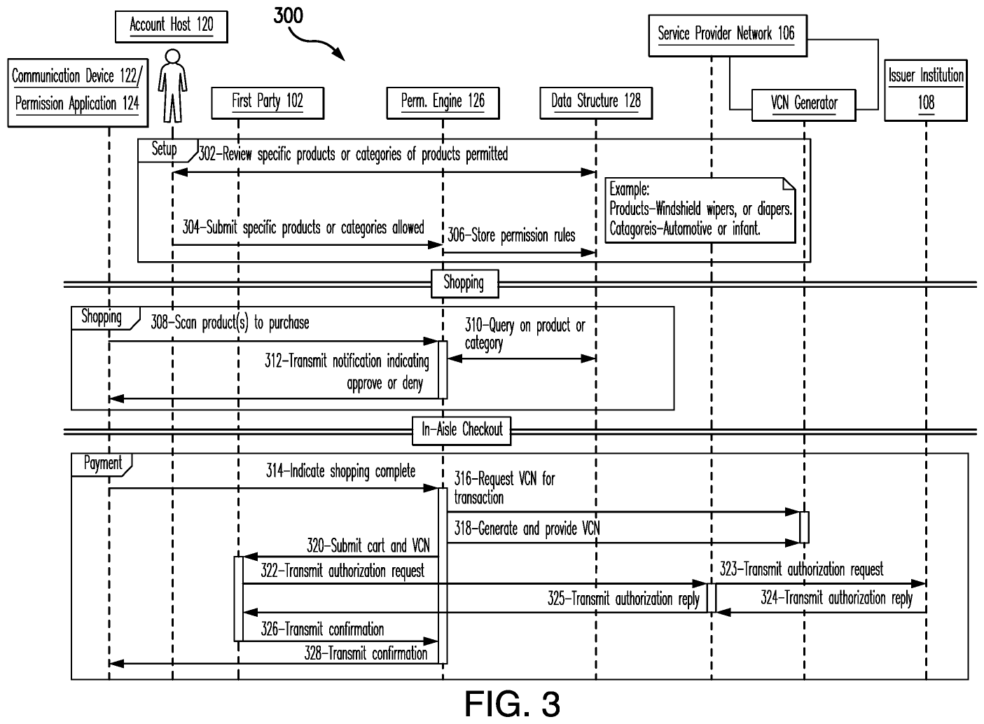

In one implementation of the system 100 (see, e.g., FIG. 3), when the user 112 is finished shopping at the merchant 102, the user 112 provides a completed shopping input to the permission application 124 of the communication device 122, for example, as part of an in-aisle checkout. In turn, the communication device 122 transmits an indication that the shopping is complete to the permission engine 126. The permission engine 126 is configured to identify the merchant 102 (e.g., based on a current location of the user 112 matching a geolocation of the merchant 102 or based on a user input, or otherwise, etc.) and to generate a virtual card number (VCN) (e.g., a one-time VCN, etc.) (e.g., via a VCN generator, etc.) for the transaction with appropriate permission for the restricted merchant 102 (i.e., a permission to allow the given transaction even though the MCC of the merchant 102 is 5200, and thus restricted). The permission engine 126 is configured to then provide the VCN to the merchant 102 along with identification of the products (and also, potentially, provide the purchase file for the given transaction to the merchant 102, the service provider network 106 and/or the issuer institution 108 (along with the estimated cost or range of estimated costs for selected product(s)). In connection therewith, the VCN is linked (or mapped) to the payment account of the user 112 (e.g., in the data structure 128, at the service provider network 106, at the issuer institution 108, etc.), whereby the given transaction at the merchant 102, based on the VCN, will be funded by the payment account issued by the issuer institution 108 and associated with the account host 120. It should be appreciated that, in some embodiments, the permission engine 126 may be configured to request the VCN from the service provider network 106, the issuer institution 108 or another entity (e.g., as shown in FIG. 3), rather than generate the VCN.

At checkout, then, the merchant 102 is configured to generate an authorization request for the transaction, based on the VCN and based on a determined transaction amount for the specific products (e.g., via a merchant terminal used as part of the in-aisle checkout for the user 112 after confirming the approved products with those in the user's shopping cart, etc.), and to transmit the authorization request to the service provider network 106 (e.g., directly, or via the acquirer institution 104 as indicated by path C in FIG. 1, etc.). The service provider network 106 is configured to verify the VCN (and to identify the payment account (e.g., map the VCN to a primary account number (PAN) for the user's payment account and append the PAN to the authorization request, etc.), etc.) and the transaction data (e.g., the transaction is directed to the correct merchant 102, etc.), to confirm that the transaction satisfies the permission rules associated with the payment account (e.g., confirm that the transaction amount is the same as or within a range of the cost determined by the permission engine 126 in the purchase file, and to transmit the authorization request to the issuer institution 108 (i.e., based on the permission rules for the payment account and despite one or more applicable restrictions to be imposed by the service provider network 106). The issuer institution 108 then generates an authorization reply (indicating the approval or decline of the transaction) and transmits the authorization reply to the merchant 102 (e.g., via the service provider network 106 and the acquirer institution 104, etc.), back along path C.

That said, it should be appreciated that the issuer institution 108 may be included in the authorization of the transaction in a conventional manner to determine whether sufficient funds or credit are available for the given transaction, etc. if the restricted transaction is initially approved by the service provider network 106. In other embodiments, though, the service provider network 106 may instead determine whether to approve or decline the transaction (as opposed to the issuer institution 108), and then generate the authorization reply for the transaction.

In the above example, the restriction for the user's payment account is implemented in the service provider network 106, and thus, as is relevant here, it is the service provider network 106 which is configured to operate differently in considering the permission request from the user 112 and to approve the restricted transaction for the given product(s) as appropriate (despite the general restriction placed thereon). Alternatively, the restriction (i.e., application of the permission rules for the user's payment account) may be implemented in the issuer institution 108, and the issuer institution 108 would be configured to approve the restricted transaction (i.e., to impose the restriction, and/or despite the restrictions, provide permission for the specific products to be purchased) and to then generate and transmit the authorization reply as appropriate.

In either case, when the transaction is approved, the merchant 102 is configured to provide a digital confirmation to the permission engine 126. And, the permission engine 126, in turn, is configured to provide the digital confirmation to the permission application 124 at the communication device 122, for viewing and/or confirmation by the user 112. In connection therewith, the digital confirmation may include an indication that the transaction was approved, an amount for the transaction, a listing of purchased products, etc. The user 112 then completes the in-aisle checkout and may leave the merchant 102 with the purchased product(s).

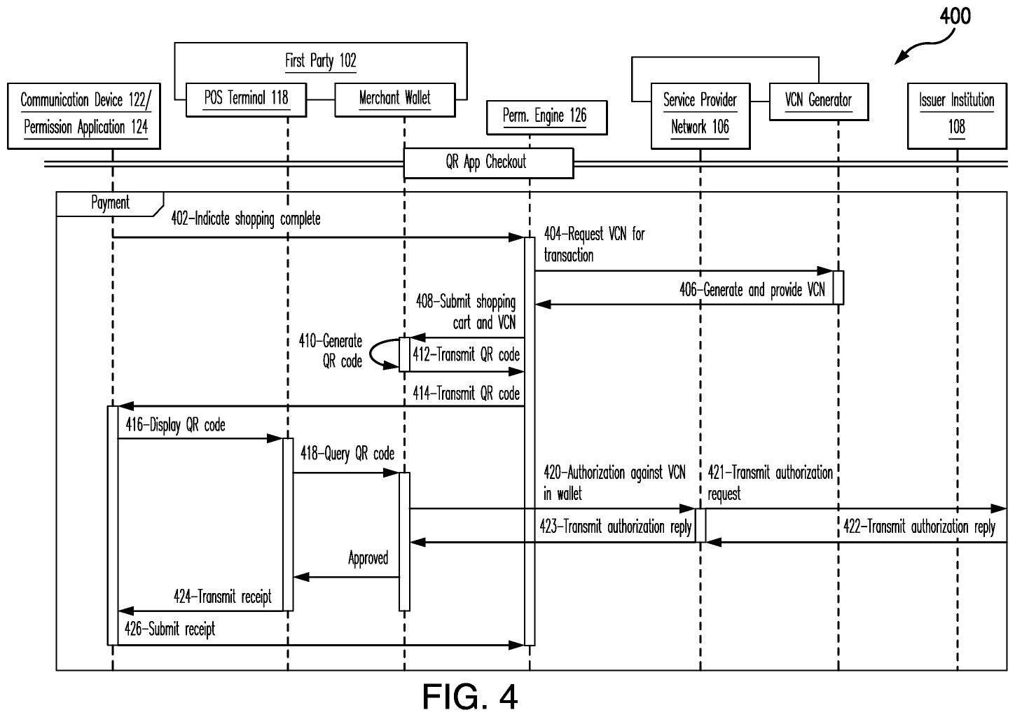

In another implementation of the system 100 (see, e.g., FIG. 4), when the user 112 is finished shopping at the merchant 102, for example, a different checkout process may be included (e.g., a QR wallet solution, etc.). Specifically, when the user 112 is finished shopping, the user 112 again provides a completed shopping input to the permission application 124 of the communication device 122, which, in turn, transmits an indication that the shopping is complete to the permission engine 126. In response, the permission engine 126 is configured to identify the merchant 102 (e.g., as described above using a geolocation of the merchant 102 or from user input, or otherwise, etc.) and to generate a VCN (e.g., via a VCN generator, etc.) (or request the VCN from the service provider network 106 or the issuer institution 108, etc.) for the transaction, and determine that permission(s) exists for the transaction at the restricted merchant 102 (i.e., a permission to allow the given transaction even though the MCC of the merchant 102 is 5200, and thus restricted). The permission engine 126 is configured to then provide the VCN to a wallet backend associated with the merchant 102 (e.g., associated with a merchant wallet of the merchant 102, etc.). The merchant wallet backend (broadly, the merchant 102) cooperates with the POS terminal 118, the service provider network 106, and the issuer institution 108 (as needed) to coordinate funding of the transaction. While the merchant wallet backend is referenced here, it should be appreciated that the permission engine 126 may coordinate with any suitable merchant payment solution (e.g., WalmartPay, MobileSpeedPass, etc.) (e.g., by providing the VCN or otherwise, etc.).

In turn, the merchant wallet backend is configured to generate a QR code (or other computer-readable indicia) that is representative of the merchant wallet and to transmit the QR code to the permission application 124 at the communication device 122. Alternatively, the merchant wallet backend may be configured to transmit the QR code to the permission engine 126, which then transmits the QR code to the permission application 124 at the communication device 122. In either case, the communication device 122, as configured by the permission engine 126, then outputs (e.g., displays, etc.) the QR code at an output device of the communication device 122. And, the POS terminal 118 is configured to then capture the QR code (along with checkout data for the products in the user's shopping cart) and to submit a query including the QR code (and checkout data) to the merchant wallet backend, regarding the given transaction. And, the merchant wallet backend (broadly, again, the merchant 102) is configured to request authorization for the transaction from the service provider network 106 (alternatively, the wallet backend may interact with the POS terminal 118, whereby the POS terminal then requests authorization for the transaction from the service provider network 106). Again, it should be appreciated that flow of data (e.g., VCNs, tokens, requests, QR codes, etc.) to/from the permission engine 126 and otherwise in FIG. 1 may be different depending on the particular merchant payment solution.

In turn, in this implementation, the service provider network 106 (alone or in combination with the issuer institution 108, potentially, depending on implementation of restrictions, as provided above) is configured to either approve or decline the transaction. Upon receipt of an approval of the transaction (i.e., the authorization reply for the transaction) from the service provider network 106, the merchant wallet backend is configured to provide approval to the POS terminal 118. The POS terminal 118, in turn, is configured to print a receipt for the transaction. And, the user 112 receives the receipt, from the merchant 102, whereupon the communication device 122, as configured by the permission application 124, scans the receipt or captures an image of the receipt, and then communicates the receipt to the permission engine 126. The permission engine 126 may be configured to store the receipt, or to verify the receipt (including its itemized product listing) against the permission provided to the user 112 for the purchase at the merchant 102 (i.e., determine that the user 112 actually purchased what he/she was approved to purchase).

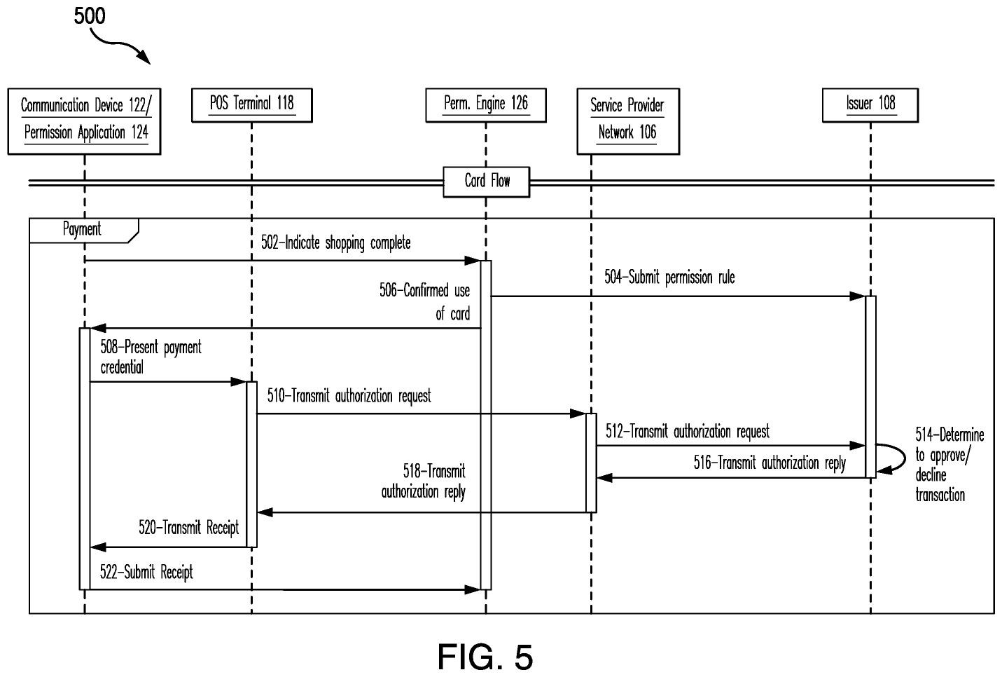

In a still further implementation of system 100 (see, e.g., FIG. 5), when the user 112 is finished shopping at the merchant 102, the user 112 again provides a completed shopping input to the permission application 124 of the communication device 122, which, in turn, transmits an indication that the shopping is complete to the permission engine 126. In response, the permission engine 126 is configured to transmit a permission instruction to the service provider network 106 and/or the issuer institution 108, whichever is configured to impose the restrictions on the payment account. The permission instruction will include at least a cost of the products permitted by the permission engine 126 and an identification of the merchant 102 (and, potentially, a listing of products from the user's shopping cart at checkout). Here, because the user 112 has only selected the windshield wipers, which were permitted at a cost of $40.00, for example, a cost of $40.00 may be provided in the permission instruction along with an identification of the merchant 102. Alternatively, the cost provided in the permission instruction may include a cost range for the product, rather than a specific amount.

In turn in this implementation, the service provider network 106 and/or the issuer institution 108 is configured to permit the transaction to proceed, despite the MCC being restricted (i.e., based on a permission to allow the given transaction even though the MCC of the merchant 102 is 5200, and thus restricted), when the transaction amount is the same as (or less than) or within the range of the cost included in the permission instruction.

And, thereafter, the user 112 proceeds to checkout at the merchant 102, by presenting (e.g. dipping, etc.) a payment account credential to the POS terminal 118. The credential may include, without limitation, a primary account number (PAN) included in a payment card or virtual wallet, etc. In response, the POS terminal 118 is configured to receive and/or retrieve the credential (e.g., at the POS terminal 118, etc.) and to communicate an authorization request for the transaction to the acquirer institution 104 (via the network 110), along path C in FIG. 1. In turn, the acquirer institution 104 communicates the authorization request to the issuer institution 108, through the service provider network 106, for authorization of the transaction (again, along path C). The issuer institution 108 is configured to then decide whether to approve or decline the transaction (i.e., impose the restrictions in this example). In this implementation, the issuer institution 108 is configured to identify the transaction to the merchant 102, to identify the permission granted by the permission engine 126, and to refrain from declining the transaction, due to the MCC restriction on the payment account, based on the transaction being consistent with the further permission instruction for the particular product 114 being purchased provided from the permission engine 126 (e.g., based on amount and merchant, etc.). It should be appreciated that the issuer institution 108 is further configured to determine if the user's payment account is in good standing and whether there is/are sufficient credit/funds to complete the transaction, etc., in addition to applying the permission instruction.

If the issuer institution 108 accepts the transaction, an authorization reply is provided back to the merchant 102, again, generally along path C, approving the transaction. The POS terminal 118, in turn, is configured to print a receipt for the transaction. And, the user 112 receives the receipt, from the merchant 102, whereupon the communication device 122, as configured by the permission application 124, scans the receipt or captures an image of the receipt, and then communicates the receipt to the permission engine 126. The permission engine 126 may be configured to store the receipt, or to verify the receipt (including its itemized product listing) against the permission provided to the user 112 for the purchase at the merchant 102.

It should be appreciated that in other embodiments, where the service provider network 106 imposes restrictions, the service provider network 106 (and not the issuer institution 108) may receive the permission instruction and permit the transaction despite the restriction.

In each of the above implementations, when the transaction is approved, the transaction is later cleared and settled by and between the merchant 102 and the acquirer institution 104 and by and between the acquirer institution 104, the service provider network 106, and the issuer institution 108 (in accordance with settlement arrangements, etc.).

While only one user 112 and one account host 120 are shown in the system 100 in FIG. 1, it should be appreciated that a different number of users and/or account hosts may be included in other system embodiments. Similarly, while only one merchant 102, one acquirer institution 104, one service provider network 106, and one issuer institution 108 are illustrated, it should be appreciated that any number of these entities (and their associated components) may be included in the system 100, or may be included as a part of systems in other embodiments, consistent with the present disclosure.

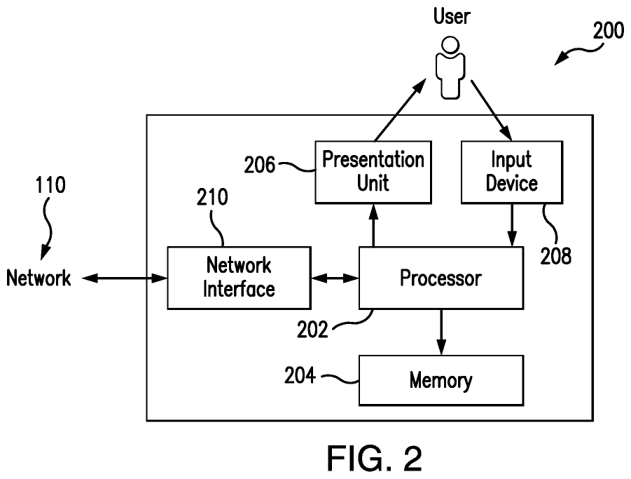

FIG. 2 illustrates an exemplary computing device 200 that can be used in the system 100. The computing device 200 may include, for example, one or more servers, workstations, personal computers, laptops, tablets, smartphones, PDAs, terminals, etc. In addition, the computing device 200 may include a single computing device, or it may include multiple computing devices located in close proximity or distributed over a geographic region, so long as the computing devices are specifically configured to function as described herein. In the system 100 of FIG. 1, each of the acquirer institution 104, the service provider network 106, and the issuer institution 108 are illustrated as including, or being implemented in, a computing device 200, coupled to (and in communication with) the network 110. In addition, the POS terminal 118, the account host 120, the communication device 122, and the permission engine 126 are also computing devices consistent with the computing device 200, and may be coupled to (and in communication with) the network 110. That said, however, the system 100, or parts thereof, should not be understood to be limited to the computing device 200, as other computing device may be employed in other system embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, listings of products, pricing for products, permission rules, restrictions, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein, thereby transforming the given computing device 200 to a special purpose device, etc. It should be appreciated that the memory 204 may include a variety of different memories, each implemented in one or more of the operations or processes described herein.

In the exemplary embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., approved/declined products, etc.), either visually or audibly to a user of the computing device 200, for example, the user 112 in the system 100 (e.g., at the communication device 122, etc.), etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, identification of a merchant 102, capture of computer-readable indicia, etc., or inputs from other computing devices. The input device 208 is coupled to (and is in communication with) the processor 202 and may include, for example, a keyboard, a pointing device, a camera, a barcode or QR code scanner, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 110. Further, in some exemplary embodiments, the computing device 200 includes the processor 202 and one or more network interfaces incorporated into or with the processor 202.

FIG. 3 illustrates an exemplary method 300 for use in permitting restricted network transactions. The exemplary method 300 is described with reference to the system 100, and with additional reference to the computing device 200. However, the methods herein should not be understood to be limited to the exemplary system 100 or the exemplary computing device 200, and likewise, the systems and the computing devices herein should not be understood to be limited to the exemplary method 300.

As shown in FIG. 3, in a setup phase of the method 300 (as indicated “Setup”), the account host 120 reviews, at 302, specific products and/or categories of product which are implicated by limitations placed on the payment account of the user 112 by the account host 120. This may include a user associated with the account host 120 accessing a listing of products from the data structure 128 or a listing of product categories from the data structure 128, which is displayed to the user at an interface at a computing device at the account host 120 (e.g., via a portal provided by the permission engine 126, the service provider network 106, or the issuer institution 108, etc.). The products may be included in a specific listing organized by category, etc.

In connection therewith, the user associated with the account host 120 is permitted to select the particular product(s) and/or the desired categories of products (whereby, regarding the categories of products, pre-populated products may already be associated with the categories) to be permitted by the given payment account, in general or specific to the user 112, and to submit, at 304, the selected specific products and/or categories of products permitted. The products or categories may be identified, prior to submission, by selecting the particular products or categories, or by selecting an existing listing of the products or categories. In this manner, the account host 120 cooperates with (and communicates with) the data structure 128 (and/or the permission engine 126) to identify products to be approved and/or to setup permission rules per product or category of products for the user 112 (or group of users), the user's payment account (or group of payment accounts), and/or the account host 120 in general. Example products may include, for instance in the above example, windshield wipers for fleet accounts (as related to automotive accounts), diapers for nanny or child care accounts (as related to infant care), etc. In various embodiments, the account host 120 may be able to select desired products and/or categories of products based on an experience level of the user 112 or a trust level of the user 112 with regard to the account host 120 (whereby different users associated with the account host's payment account may have different levels of purchase ability through the payment account).

Once the permitted products and/or categories of products are submitted by the account host 120, the permission rules for the selected products and/or categories are then generated by the permission engine 126 (based on the selection(s)) and stored, at 306, by the permission engine 126, in the data structure 128 (or elsewhere) for use by the permission engine 126 as described herein and illustrated in FIG. 3 (and also in FIGS. 4-5). In general, the permission rules may be viewed as a particular rule set for the user 112 with regard to the payment account of the account host 120 to which the user 112 has access. The rule set may then be applicable to the user 112, or to multiple users or all users that have access to the account host's payment account. In addition, the rule set may be applicable across all payment accounts associated with the account host 120 (or, it may be applicable to only specific ones of the accounts, with other rule sets then being applicable to other accounts). Further, different rule sets may be generated and applied for different users of the same payment account, etc.

Thereafter, in a shopping phase of the method 300 (as indicated “Shopping”), the user 112 scans a product to purchase, at 308, via the permission application 124, at the user's communication device 122 (e.g., while present in the merchant 102 (broadly, the first party 102 in FIG. 3), etc.) and transmits corresponding data (e.g., an identifier, etc.) for the product to the permission engine 126. In connection therewith, the permission engine 126 initially determines a location of the user 112 from the communication device and an identity of the merchant 102 based on a matching geolocation for the merchant 102 in the data structure 128 (or receives an input to the permission application 124 identifying the merchant 102, or otherwise identifies the merchant 102). As such, the permission engine 126 is notified that the merchant 102 is a restricted merchant with regard to the user 112 and the payment account provided to the user by the account host 120. As such, the permission engine 126 (upon receipt of an identifier of the scanned product, such as a UPC, etc.) queries, at 310, the data structure 128 to identify the particular product and/or seeks permission for the user 112 to purchase the product pursuant to the permission rules provided in the setup phase (e.g., in order to circumvent the broader restriction, etc.). In short, the permission engine 126 evaluates the product identified by the user 112, via the permission application against the permission rules for the user 112, account host 120 and/or payment account, etc.

When permission is available (e.g., when the product satisfies a permission rule for the account host 120, etc.), the permission engine 126 transmits, at 312, a notification indicating approval for the product to the permission application 124, at the communication device 122, which is displayed to the user 112 (allowing the user 112 to add the product to a shopping cart). In addition, the permission engine 126 generates a purchase file for the user 112 and/or the merchant 102, which includes the product identifier and a cost of the product (as determined through a listing of products and/or a price listing in the data structure 128, or other source, etc.), and stores the purchase file while the user 112 continues to shop at the merchant 102. Conversely, when the product is denied, the permission engine transmits, at 312, a notification indicating denial to the permission application 124, at the communication device 122, which is displayed to the user 112 (allowing the user 112 to return the product to a shelf). The shopping phase continues (and is repeated) until the user 112 scans all desired products to be purchased at the merchant 102 (whereby all of the desired items are appended to or included in the purchase file).

The method 300 then proceeds to a payment phase (indicated “Payment”). In the illustrated method 300, the payment phase includes an in-aisle checkout process (as described above in the system 100), whereby the method 300 may be implemented, potentially, without altering the POS terminal 118 at the merchant 102 or its associated infrastructure (e.g., the POS terminal 118 is excluded from the transaction, as shown in FIG. 3).

In particular, as part of the payment phase in this example, the user 112 indicates that the shopping session is complete via the permission application 124 at the communication device 122 (e.g., at an in-aisle checkout location of the merchant 102 (such as at a merchant attendant, etc.), etc.). In turn, the communication device 122, as configured by the permission application 124, indicates, at 314, to the permission engine 126 that the shopping is complete. In response, the permission engine 126 requests, at 316, a VCN for the transaction (e.g., from a VCN generator associated with the service provider network 106, etc.). In particular in this example, the permission engine 126 compiles a total amount for the products to be purchased and/or as identified by the user 112, via the permission application 124 (potentially, along with an indication or listing of the products). The permission engine 126 then compiles another purchase file for the transaction (or retrieves and utilizes the purchase file previously generated) and stores the same in memory (e.g., the memory 204, etc.) (or the data structure 128). The purchase file includes, again, a listing of each product and/or category of products permitted by the applicable permission rules and, when applicable, a total cost (or cost estimate) associated with the products. Then, based on the purchase file (e.g., when the user's shopping cart is consistent with the purchase file, etc.), the permission engine 126 requests the VCN for the specific transaction, as either identified to the user 112 or the user's payment account, for the total cost of the transaction.

In response, the VCN generator, as part of the service provider network 106 (in this exemplary embodiment), generates (in a generally conventional manner) and provides, at 318, the VCN for the transaction to the permission engine 126. In general, the VCN is different from the PAN for the payment account, but is linked or mapped thereto by the service provider network 106 and includes a format consistent with the PAN for the payment account, whereby it may be submitted in lieu of the PAN for a transaction to the payment account. For example, the VCN may include a sixteen digit card number and may also include an expiration date and security code (e.g., CVC, etc.). The permission engine 126 then submits, at 320, the shopping cart for the transaction as defined by the purchase file and the VCN to the merchant 102 to initiate the transaction for the products selected by the user 112 (linked based on a transaction ID, etc.) and included in the user's shopping cart, as funded by the payment account issued by the account host 120 (despite the restriction on the payment account).

In turn, the merchant 102 transmits, at 322, an authorization request for the transaction to the service provider network 106, directly or via the acquirer institution 104 (e.g., upon confirming that the products in the user's shopping cart match those provided in the purchase file from the permission engine 126, etc.). The service provider network 106 may then map the VCN to the PAN for the payment account, and transmit the authorization request (with the PAN) on to the issuer institution 108 or respond directly. When the authorization request is transmitted to the issuer institution 108, the issuer institution 108 determines whether to approve or decline the transaction. In doing so, the issuer institution 108 may interact with the permission engine 126 and/or the data structure 128 (e.g., based on a transaction ID or the PAN, etc.) to determine if a permission, contrary to the restrictions on the payment account, exists for the transaction and/or the constraints of the transaction (e.g., a transaction amount, a particular merchant, etc.). If permitted and/or consistent with the constraints, the issuer institution 108 will approve or decline the transaction based on the same. Thereafter, the issuer institution 108 generates and transmits an authorization reply to the service provider network 106 (where the service provider network 106 may then map the PAN back to the VCN and replace the PAN with the VCN in the authorization reply). Conversely, when the service provider network 106 applies the restrictions and/or permission, the service provider network 106 determines, from the data structure 128 and/or memory (i.e., including the purchase files) whether a permission exists for the transaction and/or the constraints of the transaction (e.g., a transaction amount, a particular merchant, etc.). If so, the service provider network 106 then transmits the authorization request, at 323, to the issuer institution 108, so that the issuer institution 108 is able to compile an authorization reply indicating the transaction is approved and/or denied. Regardless of whether the service provider network 106 or the issuer institution 108 determines whether to approve or decline the transaction, the issuer institution 108 generates and transmits, at 324, an authorization reply for the transaction to the service provider network 106, and the authorization reply is transmitted, at 325, from the service provider network 106, to the merchant 102 (e.g., directly or via the acquirer institution 104, etc.).

When the authorization reply is received at the merchant 102, it completes the transaction with the user 112 (whereby the user 112 is allowed to leave the merchant 102 with the purchased items) and transmits, at 326, a confirmation to the permission engine 126 indicating that the transaction is complete. The permission engine 126 then transmits, at 328, a similar confirmation to the user 112 at the permission application 124 of the communication device 122. The confirmation to the user 112 may include a listing of purchased items and a price for the transaction.

In connection with the transaction, the VCN is thereafter identified to the transaction (e.g., based on mapping of the VCN to the corresponding PAN by the service provider network 106, the issuer institution 108, etc.) as understood by the acquirer institution 104, the service provider network 106, and the issuer institution 108, whereby the transaction to the merchant 102 funded by the payment account is later cleared and settled among the institutions 104, 108 and the service provider network 106.

FIG. 4 illustrates another exemplary method 400 for use in permitting restricted network transactions. The exemplary method 400 is described with reference to the system 100, and with additional reference to the computing device 200. However, the methods herein should not be understood to be limited to the exemplary system 100 or the exemplary computing device 200, and likewise, the systems and the computing devices herein should not be understood to be limited to the exemplary method 400.

In connection therewith, the method 400 of FIG. 4 specifically illustrates a payment phase (indicated “Payment”), which may be employed with the setup and shopping phases illustrated in FIG. 3. In the illustrated method 400, the payment phase includes a QR App checkout process (as described above in the system 100).

As shown, at the outset, the communication device 122, as configured by the permission application 124, indicates, at 402, to the permission engine 126 that the shopping is complete (e.g., in response to an input by the user 112 to the permission application 124, etc.). In response, the permission engine 126 requests, at 404, a VCN for the transaction (or a token, etc.). In particular, the permission engine 126 compiles a total amount for the products to be purchased and/or as identified by the user 112, via the permission application 124. The permission engine 126 then compiles another purchase file for the transaction and stores the same in memory (e.g., the memory 204, etc.) (or the data structure 128). The purchase file includes a listing of each product and/or category of products permitted by the applicable permission rules and, when applicable, a total cost (or cost estimate) associated with the products. Then, based on the purchase file, the permission engine 126 may determine that the products selected by the user 112 satisfy the corresponding permissions set by the account host 120 and then request the VCN for the specific transaction (and the specific product(s) selected by the user 112).

In response, the VCN generator, again as part of the service provider network 106 (in this exemplary embodiment), generates and provides, at 406, the VCN for the transaction to the permission engine 126. The permission engine 126 then submits, at 408, the shopping cart as defined by the purchase file and the VCN to the merchant 102 (or a backend associated with the merchant 102 (e.g., a wallet platform, etc.)).

Upon receipt of the shopping cart and the VCN, the merchant 102 generates, at 410, a QR code or other computer-readable indicia, which is indicative of the transaction. In at least one example, the QR code encodes the VCN and/or a transaction identifier for the transaction. In one further embodiment, the QR code encodes information associated with the shopping cart and/or products therein, or part thereof. When generated, the merchant 102 transmits, at 412, the QR code or other computer-readable indicia to the permission engine 126.

The permission engine 126 then transmits, at 414, the QR code to the communication device 122, and in particular, the permission application 124, whereupon it is displayed, at 416, at the communication device 122 (e.g., at the presentation unit 206, etc.). The QR code is then presented to the POS terminal 118 at the merchant 102 (by the user 112 via the communication device 122), and the QR code is captured by the POS terminal 118. In response, the POS terminal 118 queries, at 418, the merchant 102, and in particular, the merchant backend (e.g., the merchant wallet platform, etc.), for the transaction detail associated with the QR code and/or to indicate that a transaction is to be initiated.

Based on the transaction detail, an authorization request is compiled (e.g., by the merchant wallet, by the POS terminal 118 in communication with the merchant wallet, etc.) to include the VCN (as identified from the QR code). The authorization request is then transmitted, at 420, to the service provider network 106, directly or via the acquirer institution 104, and on to the issuer institution 108, at 421 (whereby either the service provider network 106 or the issuer institution 108 maps the VCN to the PAN for the user's payment account). As explained with reference to FIG. 3, the permission rules for the transaction may be determined/applied by the service provider network 106, the issuer institution 108, or a combination thereof (via the permission engine 126, etc.). Regardless, when permitted, an authorization reply is generated and transmitted, at 422, by the issuer intuition 108 to the service provider network 106, and then the authorization reply is transmitted, at 423, from the service provider network 106 to the merchant 102 (to either the merchant backend or the POS terminal 118), directly or via the acquirer institution 104. At 424, a receipt is transmitted by the POS terminal 118 to the communication device 122. And, at 426, a receipt is submitted, from the communication device 122 (and in particular, the permission application 124) to the permission engine 126 (e.g., the same receipt from the POS terminal 118 or a different one, etc.) whereby the permission engine 126 is able to confirm that the products actually purchased by the user 112 are the same as the products for which the user 112 requested permission. The user 112 then completes the transaction at the merchant 102 and is able to leave the merchant with the purchased products from his/her shopping cart.

In various embodiments, in connection with providing the QR code to the POS terminal 118, the POS terminal 118 may use the QR code to pull permission rules for the user 112 to determine whether the products in the user's shopping cart are permitted for purchase (e.g., in conjunction with scanning the products selected by the user 112 for checkout, etc.).

Like with FIG. 3, the VCN is identified to the transaction (e.g., based on mapping of the VCN to the corresponding PAN by the service provider network 106, the issuer institution 108, etc.), as understood by the acquirer institution 104, the service provider network 106, and the issuer institution 108, whereby the transaction to the merchant 102 funded by the payment account is later cleared and settled among the institutions 104, 108 and the service provider network 106.

FIG. 5 illustrates still another exemplary method 500 for use in permitting restricted network transactions. The exemplary method 500 is described with reference to the system 100, and with additional reference to the computing device 200. However, the methods herein should not be understood to be limited to the exemplary system 100 or the exemplary computing device 200, and likewise, the systems and the computing devices herein should not be understood to be limited to the exemplary method 500.

Again, the method 500 of FIG. 5 specifically illustrates a payment phase (as indicated “Payment”) comprising a payment account transaction, which may be employed with the setup and shopping phases illustrated in FIG. 3. The payment phase of the method 500 is substantially the same as described above in the system 100.

As shown, at the outset, the communication device 122, as configured by the permission application 124, indicates, at 502, to the permission engine 126 that the shopping is complete (e.g., in response to an input by the user 112 to the permission application 124, etc.). In response, the permission engine 126 submits, at 504, a permission rule to the issuer institution 108 (or the service provider network 106 depending, at least in part, on which entity is involved in approval of the transaction). The permission rule is specific to the transaction and includes, for example, a total amount of the transaction and a merchant identifier. It should be appreciated that the permission rule may include additional information, as necessary or desired, in other embodiments. The issuer institution 108 in turn stores the permission rule in memory (e.g., the memory 204) for use as described below. In addition, the permission engine 126 confirms, at 506, that a payment device, or specifically, a payment card, associated with the payment account may be used to initiate the transaction.

In response, the communication device 122 (for a wallet provisioned payment account) (or the user 112 for a physical card) presents credentials to the POS terminal 118 of the merchant 102 for his/her payment account. In turn, the POS terminal 118 compiles and transmits, at 510, an authorization request for the transaction including the details of the transaction (e.g., the transaction amount, etc.) and the payment account credential from the communication device 122 (or payment card) to the service provider network 106, directly or via the acquirer institution 104.

In this exemplary embodiment, the service provider network 106 transmits, at 512, the authorization request to the issuer institution 108. The issuer institution 108 then determines, at 514, whether to approve or decline the transaction. In particular, the issuer institution 108 retrieves any permission rules associated with the payment account and determines whether the transaction is consistent with the permission rule(s) (e.g., based on the merchant identifier and/or transaction amount in the authorization request being consistent with the merchant identifier and/or amount (or amount range) in the permission rule, etc.). When the permission rule(s) apply, the issuer institution 108 omits application of a broader restriction on the account that would normally cause the transaction to be declined, and proceeds to approve the transaction when the user's account is in good standing and has sufficient credit. Thereafter, the issuer institution 108 compiles and transmits, at 516, an authorization reply to the service provider network 106.

The service provider network then transmits, at 518, the authorization reply to the POS terminal 118, directly or via the acquirer institution 104. At 520, a receipt is transmitted by the POS terminal 118 to the communication device 122. And, at 522, the receipt is submitted, from the communication device 122 (and in particular, the permission application 124) to the permission engine 126.

As understood from FIGS. 3-5, different payment phases are included because the permission engine 126 is sufficiently flexible to work with the different types of payment phases, for example, for VCNs generated to provide payment in an existing in-aisle payment solution (i.e., potentially involving no POS terminals), for VCNs generated to fund merchant payment solutions (e.g., merchant wallet solutions, etc.), and for physical cards/devices and/or network credentials and/or tokens on physical devices which are then unlocked for payment.

In view of the above, the systems and methods herein permit account hosts to impose broad restrictions on accounts (in the form of restricted network transactions), and to provide product level exceptions to those restrictions (to allow the restricted network transactions). Specifically, corporate and fleet account hosts may impose restrictions on network transactions involving certain merchant types (e.g., multi-category merchants, etc.) and permit other merchant types (e.g., specific merchant categories, etc.) in order to inhibit fraud and/or unauthorized or unintended purchases through their accounts. Such restrictions, for example, may prohibit purchases at warehouse stores or mega-stores (as multi-category merchants), because they sell products not in line with the purposes of the accounts (e.g., electronics, alcohol, toys, etc.). As such, these multi-category merchants may be locked out of purchases to corporate accounts and fleet accounts (simply because they sell additional products to those allowed by the corporate or fleet accounts). If the restrictions are removed, however, the potential for improper purchases of products at the multi-category merchants exists. In addressing these issues, the systems and methods herein implement a permission engine and permission application, which cooperate to create exceptions and/or permissions of certain products at such multi-category merchants (and others) or for purchases that are otherwise restricted (e.g., based on time of day, day of week, location, etc.). In so doing, the systems and methods provide not only permission for such restricted transactions, but also a mechanism to verify the underlying purchase of the products to thereby limit or eliminate abuses of the corporate and/or fleet accounts used in the transactions (or other accounts provided by account hosts).

In addition, in one exemplary embodiment of the present disclosure, a computer-implemented method for use in permitting restricted network transactions is provided. The method generally includes capturing, at a communication device, an image of a indicia associated with a product and transmitting, by the communication device, a product identifier, based on the indicia, to a permission engine computing device thereby requesting permission to purchase the product from a merchant associated with a restricted merchant category through a payment account of a user associated with the communication device. The method also includes identifying the merchant to the permission engine computing device, and scanning, by the communication device, a receipt for a transaction for the product from the merchant and transmitting the receipt to the permission engine computing device.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the method steps recited in the claims below.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in permitting restricted network transactions, the method comprising:
receiving, at a computing device, a product identifier associated with a product from a user via a communication device, the product offered for sale by a merchant associated with a restricted merchant category for a payment account associated with the user, whereby the payment account is restricted from funding a transaction for the product at the merchant based on the restricted merchant category;
identifying, by the computing device, the product based on the identifier, from a listing of products included in a data structure;
determining, by the computing device, whether the product is permitted based on one or more permission rules associated with an account host for the payment account; and
transmitting, by the computing device, an approve notification for the product to the user, at the communication device, when the product is permitted by the one or more permission rules, thereby informing the user that the payment account is available to fund a transaction for the product at the merchant even though the merchant is associated with the restricted merchant category.

2. The computer-implemented method of claim 1, further comprising transmitting, by the computing device, a permission instruction for the product to an entity associated with the payment account, whereby a transaction for the product is permitted by the entity despite the merchant being associated with the restricted merchant category; and
wherein the entity includes an issuer of the payment account and/or a service provider network associated with the payment account.

3. The computer-implemented method of claim 2, further comprising determining an estimated cost of the identified product; and
wherein the permission instruction includes one of the estimated cost and a price range including the estimated cost.

4. The computer-implemented method of claim 2, wherein the permission instruction includes an estimated cost for the product; and
wherein the method further comprises:
receiving an authorization request for the transaction for the product; and
approving the authorization request for the transition when a transaction amount included in the authorization request is equal to the estimated cost and/or is within a range of the estimated cost of the product.

5. The computer-implemented method of claim 2, wherein the product includes multiple products and the permission instruction includes an estimated cost for the multiple products in total, or a range of the estimated cost for the multiple products in total.

6. The computer-implemented method of claim 1, further comprising storing the one or more permission rules in the data structure based on one or more inputs from a user associated with the account host.

7. The computer-implemented method of claim 6, wherein the listing of products is specific to the merchant.

8. The computer-implemented method of claim 1, further comprising:
generating a virtual account number (VCN) for a transaction with the merchant for the product, the VCN associated with the payment account; and
transmitting the VCN to the merchant, thereby allowing the merchant to submit an authorization request for the transaction including the VCN.

9. The computer-implemented method of claim 1, further comprising:
obtaining a virtual account number (VCN) for a transaction with the merchant for the product, the VCN associated with the payment account;
transmitting the VCN to the merchant, thereby allowing the merchant to submit an authorization request for the transaction including the VCN;
receiving a confirmation of purchase of the product from the merchant; and
transmitting the confirmation to the user, at the communication device.

10. The computer-implemented method of claim 1, further comprising transmitting a virtual account number (VCN) for a transaction to a merchant wallet backend, the VCN associated with the payment account, thereby permitting the merchant wallet backend to provide indicia indicative of the VCN to the user.

11. The computer-implemented method of claim 10, wherein the indicia includes a QR code: and
wherein the method further comprises:
receiving, from the merchant wallet backend, the QR code; and
transmitting the QR code to the communication device associated with the user, thereby allowing the user to proceed with the transaction for the product despite the merchant being associated with the restricted merchant category.

12. The computer-implemented method of claim 1, wherein the account host includes a business and the user includes an employee of the business; and
wherein the restricted merchant category includes a merchant category code (MCC) for a multi-category merchant.

13. A non-transitory computer readable storage medium including executable instructions for use in facilitating restricted network transactions, which when executed by at least one processor, cause the at least one processor to:
receive a product identifier associated with a product from a user via a communication device, the product offered for sale by a merchant associated with a restricted merchant category for a payment account associated with the user, whereby the payment account is restricted from funding a transaction for the product at the merchant based on the restricted merchant category;
identify the product based on the identifier, from a listing of products included in a data structure;
determine whether the product is permitted based on one or more permission rules associated with an account host for the payment account; and
transmit an approve notification for the product to the user, at the communication device, when the product is permitted by the one or more permission rules, thereby informing the user that the payment account is available to fund a transaction for the product at the merchant even though the merchant is associated with the restricted merchant category.

14. The non-transitory computer readable storage medium of claim 13, wherein the executable instructions, when executed by the at least one processor, further cause the at least one processor to:
generate a virtual account number (VCN) for a transaction with the merchant for the product, the VCN associated with the payment account; and
transmit the VCN to the merchant, thereby allowing the merchant to submit an authorization request for the transaction including the VCN.

15. The non-transitory computer readable storage medium of claim 13, wherein the executable instructions, when executed by the at least one processor, further cause the at least one processor to:
obtain a virtual account number (VCN) for a transaction with the merchant for the product, the VCN associated with the payment account;
transmit the VCN to the merchant, thereby allowing the merchant to submit an authorization request for the transaction including the VCN;
receive a confirmation of purchase of the product from the merchant; and
transmit the confirmation to the user, at the communication device.

16. The non-transitory computer readable storage medium of claim 13, wherein the executable instructions, when executed by the at least one processor, further cause the at least one processor to transmit a virtual account number (VCN) for a transaction to a merchant wallet backend, the VCN associated with the payment account, thereby permitting the merchant wallet backend to provide indicia indicative of the VCN to the user.

17. The non-transitory computer readable storage medium of claim 13, wherein the executable instructions, when executed by the at least one processor, further cause the at least one processor to transmit a permission instruction for the product to issuer of the payment account and/or a service provider network associated with the payment account, the permission instruction including an estimated cost for the product; whereby a transaction for the product is permitted by the issuer and/or the service provider network when a transaction amount for the transaction is equal to the estimated cost and/or is within a range of the estimated cost of the product, despite the merchant being associated with the restricted merchant category.

18. A computer-implemented method for use in permitting restricted network transactions, the method comprising:
requesting, by the computing device, a virtual account number (VCN) for a transaction by a user at a merchant, the VCN associated with a payment account of the user;
obtaining, by the computing device, the VCN;
transmitting, by the computing device, to the merchant, the VCN and a shopping cart including a product associated with the transaction; and
receiving, at the computing device, from the merchant, a confirmation that the transaction is complete.

19. The computer-implemented method of claim 18, further comprising:
receiving, at the computing device, a scanned indicia for the product from a communication device associated with the user, prior to requesting the VCN;
searching in a data structure for the product associated with the transaction and determining that the product is consistent with at least one permission rule associated with the payment account; and
including, by the computing device, the product in a purchase file for the user.

20. The computer-implemented method of claim 19, further comprising confirming, by the computing device, a consistency of the transaction with the purchase file based on a merchant ID for the merchant and a transaction amount for the transaction prior to requesting the VCN.
